(19) United States
(12) Patent Application Publication
(10) Pub. No.: US 2008/0156211 A1
(43) Pub. Date: Jul. 3, 2008

(54) Mountable Note Dispenser

(75) Inventors: Brett R. Moody, Corona Del Mar, CA (US); Brad Davis, Corona Del Mar, CA (US)

Correspondence Address: MOORE & HANSEN, PLLP, 225 SOUTH SIXTH ST, MINNEAPOLIS, MN, 55402, US

(73) Assignee: Cosco Industries, Inc., North Mankato, MN (US)

(21) Appl. No.: 12/051,466

(22) Filed: Mar. 19, 2008

Related U.S. Application Data
(62) Division of application No. 10/769,516, filed on Jan. 30, 2004.

(51) Int. Cl. B41L 47/00; B65H 1/00

(52) U.S. Cl. 101/368; 221/282

(57) ABSTRACT

A note dispenser attached to an article with a wall for holding a note pad between the dispenser and the article wall. The dispenser has a front wall spaced from the article wall and defines a hole for providing access to notes from the note pad through the front wall. The dispenser has at least one sidewall extending from the front wall and toward the article wall. The sidewalls have an edge opposing the article wall so that the note pad is surrounded by the front wall, the article wall and the sidewalls. At least one sidewall is configured for engaging the article wall which connects the note dispenser to the article wall.

### TECHNICAL FIELD OF THE INVENTION

The invention relates generally to dispensers for stacks of adhesive notes or flags, and more particularly to note dispensers for placement of note pads on articles or devices such as hand-held devices.

### BACKGROUND OF THE INVENTION

Adhesive note (or flag or sheet) stacks such as 3M POST-IT® Note Pads are known and available. Each note in the stack has a band of adhesive coated on one edge. Conventional dispensers cover the stack except for a slit that exposes the top most note on the stack. The notes are stacked with the adhesive coated on alternating ends so that when a stack is placed in a conventional dispenser, pulling the top most note through the slot and out of the dispenser positions and exposes the next note in the stack where it is accessible for use.

Many hand-held devices, such as ink stamps or stampers for example, are used while manipulating papers or documents. When such hand held devices are used, frequently the person using the hand-held device also has the task of finding certain language or words on the documents and then tagging the location of the sought words on the documents with a POST-IT® flag or note. Either these two processes are performed separately (first a pile of papers is stamped and, then reviewed separately for tagging) which wastes a tremendous amount of time, or the processes are performed simultaneously. If performed simultaneously, while the documents are stamped, a document may be found that must be tagged. Then, the stamper is placed down and the person either reaches for a separate note pad nearby or leaves the area entirely to obtain the note pad and retrieve one of the notes. Either way, the process is awkward and wastes time, especially when papers are bound together in some way so that saving the place in a stack of papers for tagging is extremely cumbersome. Of course when the note pad is located away from the hand-held device, it is easy to lose the note pad, wasting even more time.

Thus, a need exists to place the note pad where it is convenient and easy to find yet does not interfere with the operation of the hand held device. These and other objects and advantages will be apparent from the following specification.

### SUMMARY OF THE INVENTION

The problems mentioned above are solved by the present invention, in which in a first aspect, a note dispenser is attached to an article with a wall for holding a note pad between the dispenser and the article wall. The dispenser is extremely adaptable so that the article can be almost anything that the dispenser can attach to such as bulletin/communication boards, frames, building walls, large or small appliances and hand-held devices such as ink, stampers, staplers, tape dispensers, telephone equipment or desk organizers. It may be attached to electronics, computers or other machines such as copiers, or fax machines. It may even be attached to furniture such as desks and book shelves. The article is not limited to any one thing, device, machine or apparatus although it is particularly suited for hand held devices herein.

The note dispenser has a front wall spaced from the article wall and defines a hole for providing access to notes of the note, pad through the front wall. At least one sidewall is provided and extends from the front wall and toward the article wall. The sidewall(s) have an edge opposing the article wall such that the note pad is surrounded by the front wall, the article wall and the sidewall(s). The sidewall(s), rather than any back wall, engage the article wall for connecting the dispenser to the article wall.

In one specific example, the article is a hand-held ink stamper. The stamper has a main body with an upper portion and a lower portion with a wall. A cap is movably disposed over the upper portion for operating the stamper. A note pad is positioned between a note dispenser and the wall of the lower portion. The note dispenser is attached to the stamper wall and is sized and shaped to avoid interfering with motion of said cap.

The following detailed description of embodiments of the invention, taken in conjunction with the appended claims and accompanying drawings, provide a more complete understanding of the nature and scope of the invention.

### BRIEF DESCRIPTION OF THE DRAWINGS

FIG. 1 is a front perspective view of a note dispenser on a stamper and holding a note pad in accordance with the present invention;

FIG. 2 is a front elevation of the note dispenser on the stamper in accordance with the present invention;

FIG. 3 is a right side elevation of the note dispenser with a portion cut away on the stamper in accordance with the present invention;

FIG. 4 is a top view of the note dispenser on the stamper in accordance with the present invention;

FIG. 4A is a close-up, partial, cross-sectional view of a portion of the stamper engaging the dispenser in accordance with the present invention;

FIG. 5 is a back side perspective view of a dispenser in accordance with the present invention; and

FIG. 6 is a front perspective view of an alternative stamper with the dispenser in accordance with the present invention.

### DESCRIPTION OF THE PREFERRED EMBODIMENTS

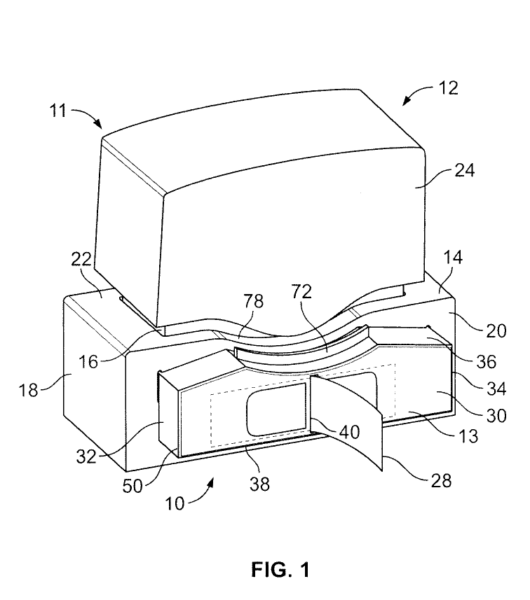

Referring to FIGS. 1-5, a note dispenser 10 is removably attached to an article 11 such as the ink stamper 12 shown here. Instead of the ink stamper, the article can be any object with a wall (horizontal, vertical or other orientation) that the dispenser 10 can attach to. The dispenser, however, is particularly suited for attaching to hand-held devices such as the ink stamper as described below.

The ink stamper 12 is a hand-held stamper with a main body 14 an upper portion 16 and a lower portion 18. The lower portion 18 has a vertical wall 20 and a ledge or horizontal top wall 22 connecting the lower portion 18 to the upper portion 16. A cap 24 is disposed to move vertically (up and down) over the upper portion 16 and is attached to an internal inking mechanism (not shown) that is pushed downward to contact paper placed under the stamper 12 when the cap is pushed downward over the upper portion 16. While a Cosco Industries, Inc. ACCUSTAMP™ is shown, it will be understood that the note dispenser can attach to many different styles, sizes or configurations of ink stampers or other articles as described above.

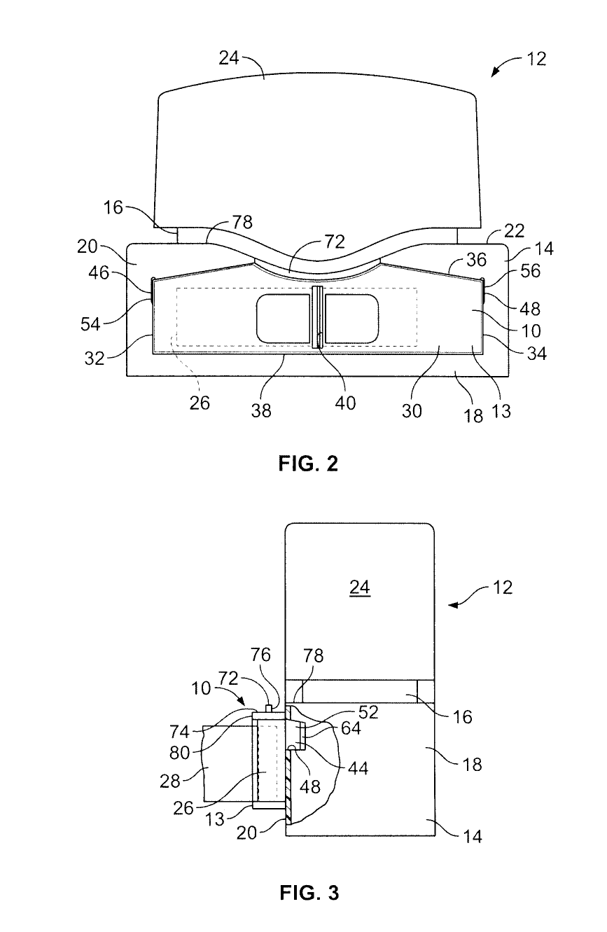

The note dispenser 10 can hold any note, flag, sheet or paper pad, stack or pile that will fit within the note dispenser and has an adhesive so that pulling a top note from the pad pulls the next note into position on the top of the pad where it is accessible for use. One such example note pad 26 (shown in dash on FIG. 2) is a POST-IT® Note Pad that has a strip of adhesive on alternating ends of the notes 28 as they are piled on the note pad.

The note dispenser 10 attaches to the vertical wall 20 of the lower portion 18 of the stamper 12. In the preferred embodiment, the dispenser 10 has a backless body 13 that holds the note pad 26 directly between it and the wall 20. In other words, the note pad 10 directly opposes, and is free to directly abut, both the note dispenser 10 and the wall 20 of the stamper 12, which eliminates material and provides a very economical design.

More specifically, the dispenser 10 has a front wall 30 spaced away from, and preferably generally parallel to, the stamper wall 20. A left sidewall 32, right sidewall, 34, a top sidewall 36 and bottom sidewall 38 are all preferably integrally formed with the front wall 30 and extend from the front wall toward the stamper or article wall 20. Each of the sidewalls abuts the stamper wall 20, aid the bottom sidewall 38 supports the note pad 26. The note pad 26 is held between the front wall 30, side walls 32, 34, 36, 38 and stamper wall 20 to entirely enclose the note pad 26 except for a hole or vertically extending slot 40 defined by the front wall 30.

The slot 40 provides access to the top most note 28 of the note pad 26 and defines a longitudinal direction (of the slot) that has a length that is slightly longer than the width of the notes 28 on the note pad 26. The slot 40 extends generally perpendicular to the longitudinal lengths of the note pad 26 and dispenser 10. Thus, the slot may extend in different directions other than vertical depending on the positioning of the dispenser. Inner edges 41 of the slot 40, as best seen in FIG. 5, are rounded to avoid a sharp corner that would interfere with the motion of the notes as they are pulled from the note pad. The inner edges 41 are formed by indents 43.

Referring to FIGS. 3-5, the right and left sidewalls 32 and 34 each have a projection 42, 44 extending toward, and respectively engaging, apertures 46, 48 on the stamper 12. In FIG. 3, a portion of the stamper 12 is cut away to show this engagement on the right side (the left side is a mirror image of the right side).

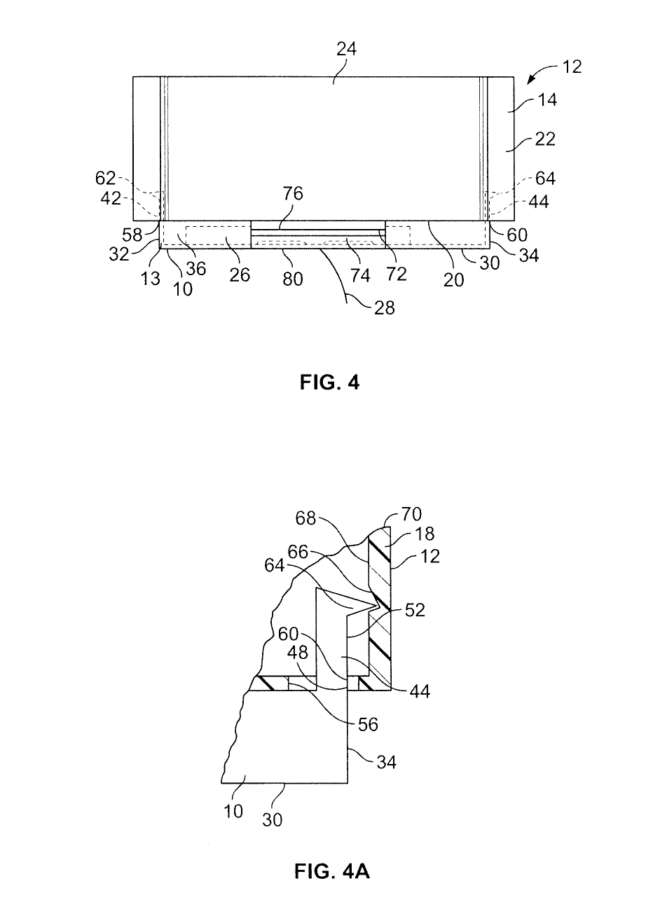

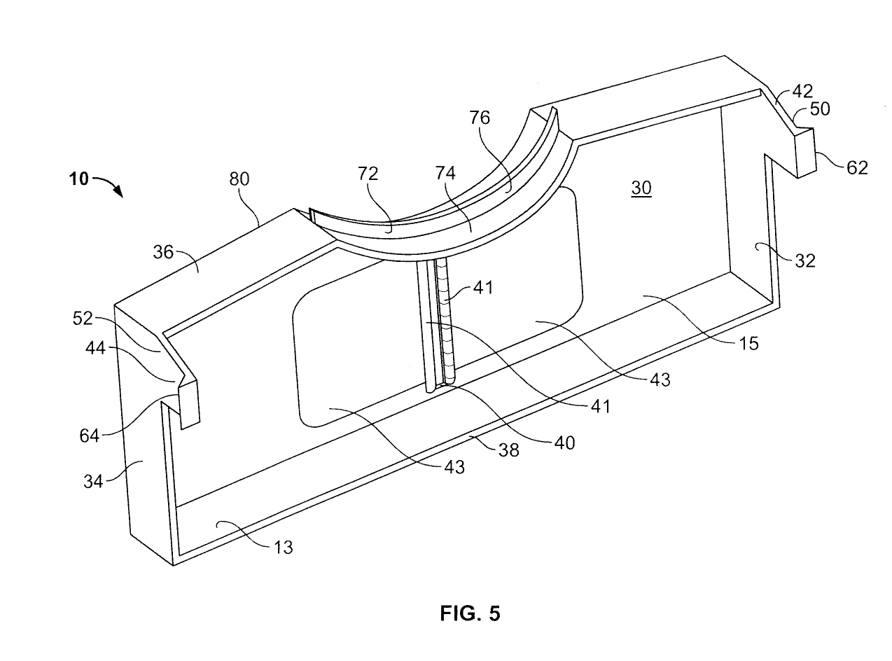

The two projections 42, 44 each have an outward facing side 50, 52. The apertures 46, 48 are respectively defined by rims 54, 56 on the article wall 20. Each rim 54, 56 has an outer edge 58, 60 (FIGS. 3, 4 and 4A).

The distance between the outward facing sides 50, 52 of the projections 42, 44 is longer than the distance between the outer edges 58, 60 of the rims 54, 56 of the apertures 46, 48 so that the note dispenser 10 must be compressed in a direction generally parallel to the distances between the aperture outer edges 58, 60 for fitting both the projections 42, 44 into the apertures. This provides a snug or tight (here horizontal) fit for maintaining the note dispenser 10 on the article wall 20.

In one alternative engagement between the dispenser 10 and stamper 12, the projections 42, 44 each have a tip with a point or widened portion to form a hook 62, 64. The hooks 62, 64 engage the rims 54, 56 of the article wall 20 whenever the dispenser 10 is moved away from the article wall 20. This prevents unintentional removal of the dispenser 10 from the stamper 12.

While not in the preferred embodiment, the hooks or widened portions 62, 64 may extend exteriorly relative to the front wall 30 and engage a groove 66 formed on an internal surface 68 of an end wall 70 of the stamper or article 12. This will provide further engagement between the note dispenser 10 and stamper 12.

Referring to FIGS. 1-5, the top sidewall 36 has a grip rib or projection 72 extending from its exterior surface 74. The grip rib 72 provides a prying surface 76 for a finger of hand to engage and pull on in a direction away from the article wall to remove the note dispenser 10 from the article wall 20. While the grip rib 72 is shown on the top sidewall 36, it will be appreciated that the grip rib 72 could be on any one or combination of sidewalls, 32, 34, 36 and/or 38.

In another aspect of the invention, the ledge 22 of the lower portion 18 of the stamper 12 has a non-flat contour 78 (here a concave groove or dip) for avoiding fingers of a hand manipulating the cap 24 of the stamper 12. At least a portion of a top edge 80 of the dispenser front wall 30 as well as at least a portion of the horizontal top sidewall 36 of the dispenser have a contour that aligns with or matches (has the same shape as) the contour 78 of the ledge 22 so that the note dispenser 10 also avoids interference with operation of the cap 24. Preferably, the dispenser top edge 80, top sidewall 36 and/or the rib 72 define the highest points on the note dispenser 10 and are disposed at the same height as, or entirely below, the ledge 22.

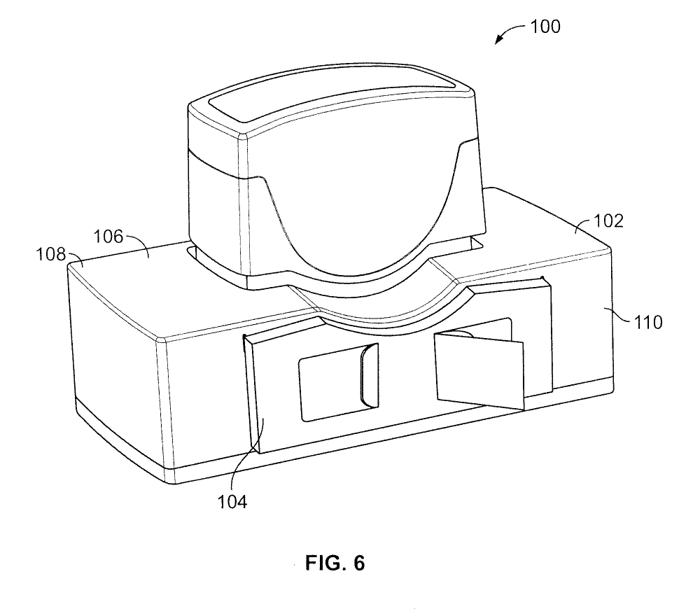

Referring to FIG. 6, an alternative stamper 100 is shown with a much larger lower portion 102. All other features are the same as that shown in FIGS. 1-5. It will be appreciated, however, that with such a large lower portion, it would be possible to place a note dispenser 104 on a top horizontal wall 106 forming ledge 108 instead of vertical wall 110 as shown.

While the note dispenser 10 is made of a transparent plastic to be able to determine when the dispenser needs to be refilled, it can be any appropriate material. The stamper or article wall 20 can also be any appropriate material that is compatible with the engagement of the dispenser 10 and the stamper or article 12.

It will be appreciated that while the dispenser 10 is attached at the sidewalls 32, 34, many other configurations are possible including providing a single projection at one of the sidewalls 32, 34, 38 if the dispenser is held tightly enough or hanging the dispenser from one projection extending from the top sidewall 36. Other configuration may eliminate sidewalls by using projecting structures such as posts, beams, pins, etc. for extending from the front wall 30 to project to, and engage, the stamper or article wall 20.

It will also be appreciated that many different ways exist to connect the dispenser 10 to the article or stamper 12. The projections 42, 44 may have no hook or hooks in different directions than that disclosed here. Projections may extend from the article or stamper 12 to the dispenser 10 to engage sidewalls or other portions of the dispenser. Other connections to the sidewalls or extensions from the front wall 30 of the dispenser using any engagement mechanism or fastener that is similar in function to the present hook, although not as economical as the present design, are contemplated. This would include, but is not limited to, a dispenser back wall with hooks or the like.

In operation, a note pad 26 is placed on the interior side 15 (FIG. 5) of the note dispenser 10 and the top most note 28 is placed through the slot 40. Then, to place the note dispenser on the stamper 12—or to take it off of the stamper—the sidewalls 32, 34 are squeezed slightly to compress the note dispenser 10 and to move the projections 42, 44 into or out of the apertures 46, 48 of the stamper wall 20. Once attached the stamper can be operated without the note dispenser falling off and note pads can be obtained through slot 40. The note dispenser can be removed whenever the dispenser needs to be refilled.

The advantages of the present invention are now apparent. The note dispenser 10 is configured to attach to any article, including ink stampers 12, where the note pad is conveniently located and easy to find. The simple and economical design permits the dispenser 10 to be attached to the stamper 12 on its sidewalls 32, 34 and requires no back between the stamper 12 and the note pad 26 disposed in the note dispenser 10.

While the preferred embodiments of the invention have been shown and described, it will be apparent to those skilled in the art that changes and modifications may be made therein without departing from the spirit of the invention, the scope of which is defined by the appended claims.

1-16. (canceled)

17. A hand-held ink stamper, comprising: a main body with an upper portion and a lower portion, at least one of the portions having a wall; an inking mechanism for stamping a surface with ink when actuated by vertical motion of the upper portion; and a note dispenser for a note pad including a stack of notes disposed on said wall, said note pad being disposed between said dispenser and said wall and sized to avoid interfering with motion of said upper portion such that the note dispenser operates independently and without separation from the hand-held article while the internal inking mechanism is actuated by the upper portion.

18. The ink stamper of claim 17, wherein said wall is a vertical wall, and the stamper body further includes a horizontal ledge connecting said upper portion to said lower portion, a highest point of said note dispenser remaining at the same height as said ledge or entirely below said ledge.

19. The ink stamper of claim 18, wherein said ledge has a non-flat contour, and wherein said dispenser has a front wall spaced from, and extending generally parallel to, said wall of said lower portion, said front wall having a top edge with a contour that matches at least a portion of said non-flat contour of said ledge.

20. The ink stamper of claim 19, wherein said dispenser has a top sidewall extending horizontally from said front wall and toward said vertical wall and shaped to match said contour.

21-22. (canceled)

23. The ink stamper of claim 17, in which the dispenser is disposed vertically against the wall, and the dispenser comprises a horizontal bottom sidewall supporting the note pad.

24. The ink stamper of claim 17, in which the dispenser further comprises at least one projection adapted to be received by a corresponding aperture defined by the wall, in which engagement of the projection with the aperture holds the dispenser on the wall.

25. The ink stamper of claim 24, in which the dispenser comprises opposite left and right projections.

26. The ink stamper of claim 24, in which the dispenser is adapted to be compressed for fitting each projection into its corresponding aperture to form a tight fit for mounting the note dispenser on the wall.

27. The ink stamper of claim 24, in which at least one projection comprises a tip having a widened portion to form a hook adapted for engaging the corresponding aperture to prevent unintentional removal of the dispenser from the stamper.

28. The ink stamper of claim 17, in which the dispenser further comprises a grip rib to provide a surface to engage and pull the dispenser away from the wall.

29. The ink stamper of claim 28, in which the dispenser is disposed vertically, and the grip rib is formed in a top sidewall of the note dispenser.

30. The ink stamper of claim 17, in which the note dispenser comprises a top sidewall and a bottom sidewall and left and right sidewalls, which together enclose the note pad between the note dispenser and the wall.

31. The ink stamper of claim 17, in which the notepad is enclosed in a pre-supplied inner dispenser, and the note dispenser is sized to receive and cover the inner dispenser.

32. The ink stamper of claim 17, in which the wall to which the dispenser is disposed is located on the upper portion.

33. The ink stamper of claim 17, in which the wall to which the dispenser is disposed is located on the lower portion.

34. The ink stamper of claim 17, in which the dispenser is transparent.

35. The ink stamper of claim 17, in which the dispenser is adapted to be removably attached to the wall for replacing the notepad.

36. The ink stamper of claim 17, in which the dispenser defines a slot which provides access to the notepad.
